(19) United States
(12) Patent Application Publication
(10) Pub. No.: US 2017/0197784 A1
(43) Pub. Date: Jul. 13, 2017

(54) BLOW MOLDED WASTE CART WITH HANDLE

(71) Applicants: Bruce Hamilton, Jefferson, OH (US); Brian Moroney, Mentor, OH (US); Douglas Eck, Wichita, KS (US)

(72) Inventors: Bruce Hamilton, Jefferson, OH (US); Brian Moroney, Mentor, OH (US); Douglas Eck, Wichita, KS (US)

(73) Assignee: Toledo Molding & Die, Inc., Toledo, OH (US)

(21) Appl. No.: 15/172,426

(22) Filed: Jun. 3, 2016

Related U.S. Application Data
(60) Provisional application No. 62/170,517, filed on Jun. 3, 2015.

(51) Int. Cl. B65F 1/14; B29C 49/48

(52) U.S. Cl. CPC B65F 1/1452; B29C 49/4802; B65F 2250/114; B29L 2031/712

(57) ABSTRACT

A body for a blow-molded waste cart and a waste cart having a blow-molded hollow body with a rear wall and a handle keyway formed in the rear wall and a handle installed in the keyway. The body may include a detent formed in the rear wall of the body that engages a projection formed on the handle assembly. The keyway may be formed of a number of spaced trapezoidal slots with undercut sections that mate with a plurality of spaced trapezoidal keys on the handle. The waste cart, as well as the handle assembly may be blow-molded.

### TECHNICAL FIELD AND INDUSTRIAL APPLICABILITY OF THE INVENTION

The present invention relates to blow molded waste carts, also referred to as wheeled trashcans, which are substantially constructed of blow-molded polymeric materials. The present invention related specifically to a blow molded cart that includes a receiver for a handle, without the use of adhesives of mechanical fasteners. The handle provides a strong and resilient handle and lid support without the use of mechanical fasteners or adhesives.

### BACKGROUND OF THE INVENTION

Blow molding is used to produce generally hollow plastic parts by melting plastic infeed material, forming a parison (a tubular piece of plastic), placing the parison into a mold and blowing air into the parison to force the plastic out to match the mold. The plastic cools and hardens within the mold and the mold is opened the part is ejected. The main bodies of waste carts have been made by the blow molding process for many years; however, previous blow-molded waste carts required a substantial number of additional mechanically attached parts. The use of mechanical attachments increases the cost of manufacture while increasing the number of potential failure points while in use.

### SUMMARY OF THE INVENTION

The present invention relates to blow-molded waste carts and more specifically to waste carts with a handle attached to the waste cart without the use of adhesives or mechanical attachments. The use of the handle stiffens the cart and may produce a more rugged cart while in use. Specifically, a body for a blow-molded waste cart and a waste cart is disclosed having a blow-molded hollow body with a rear wall and a handle keyway formed in the rear wall and a handle installed in the keyway. The body may include a detent formed in the rear wall of the body that engages a projection formed on the handle assembly. The keyway may be formed of a number of spaced trapezoidal slots with undercut sections that mate with a plurality of spaced trapezoidal keys on the handle. The waste cart, as well as the handle assembly may be blow-molded.

### BRIEF DESCRIPTION OF THE DRAWING

A more complete appreciation of the invention and the many embodiments thereof will be readily obtained as the same becomes better understood by reference to the following detailed description when considered in connection with the accompanying drawings, wherein:

FIG. 1 illustrates a side view of a blow-molded waste cart including an indented section for a handle in accordance with the present invention;

FIG. 1B illustrates a side view of a blow-molded waste cart including an indented section for a handle in accordance with the present invention;

FIG. 1C illustrates a perspective view of a blow-molded waste cart an indented section for a handle in accordance with the present invention;

FIG. 2A illustrates an internal perspective view of a blow-molded waste cart including an indented section for a handle in accordance with the present invention;

FIG. 2B illustrates a lower perspective view of a blow-molded waste cart including an indented section for a handle in accordance with the present invention;

FIG. 3A illustrates a handle in an indented section in accordance with the present invention; and

FIG. 3B illustrates a handle for use in an indented section of a waste cart in accordance with the present invention.

### DETAILED DESCRIPTION AND PREFERRED EMBODIMENTS OF THE INVENTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of ingredients, properties such as molecular weight, reaction conditions, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

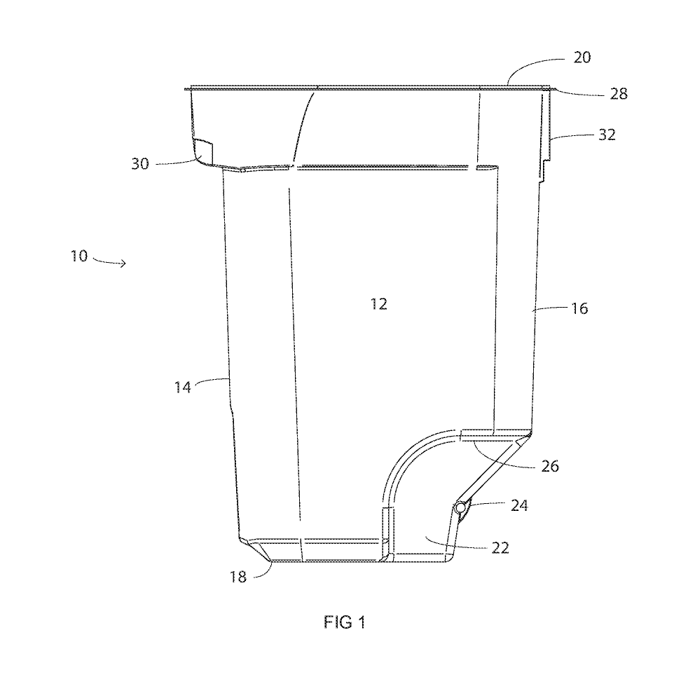

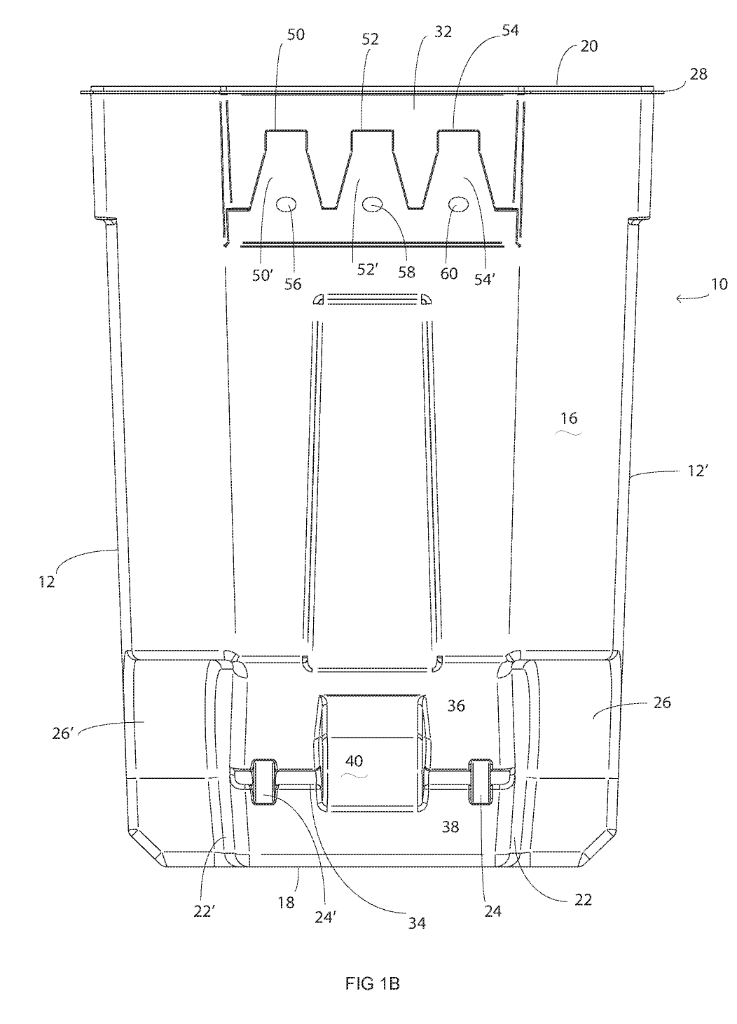

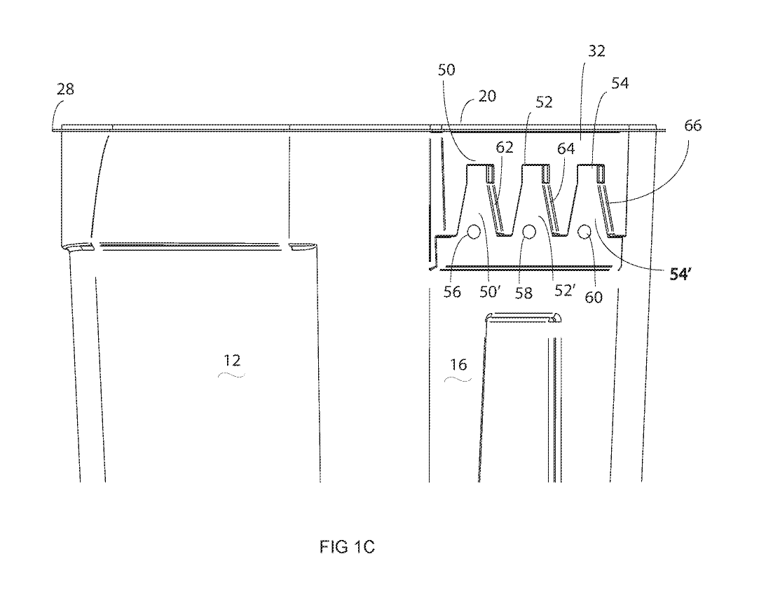

A blow molded waste cart is shown in FIG. 1. The cart 10 includes a hollow central body formed by front wall 14, rear wall 16, right wall 12, left wall 12′ and floor 18 such that waste may be received within the hollow central body. Cart body 10 molded keyway 32 for a handle and cutouts 22 with fender sections 26 in sidewalls 12, 12′ for wheels (not shown) to be mounted on an axle retained by axle strap 24. Waste cart 10 may be tilted to roll on the wheels and returned to a vertical orientation to rest in a stable, vertical position. The top of waste cart 10 includes an upper rim 20 and may optionally include a reinforcing flange 28. Reinforced lift pocket 30 may also be included.

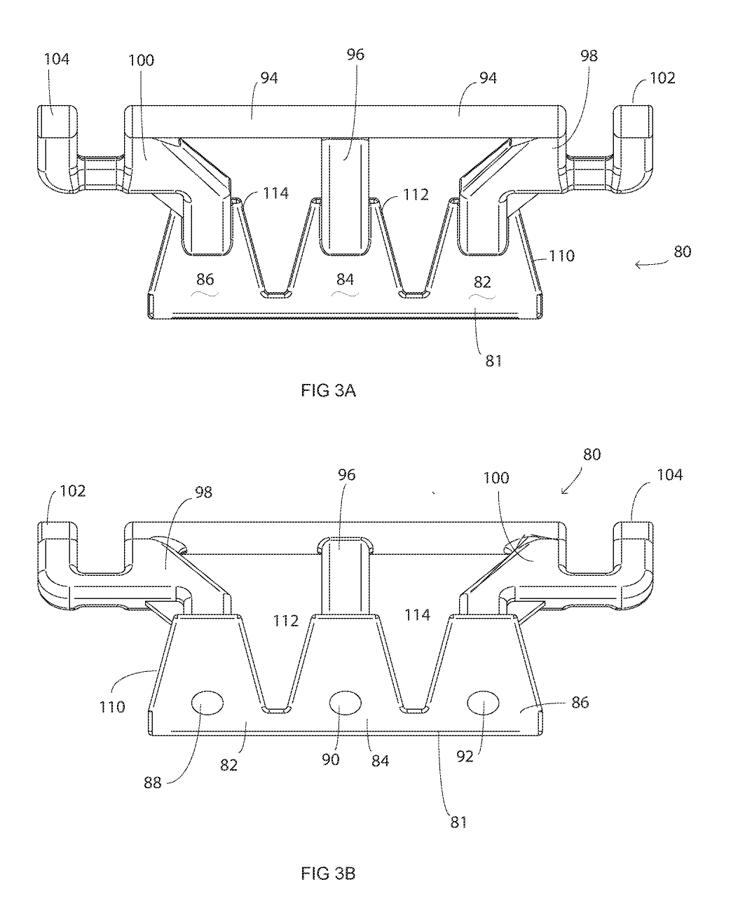

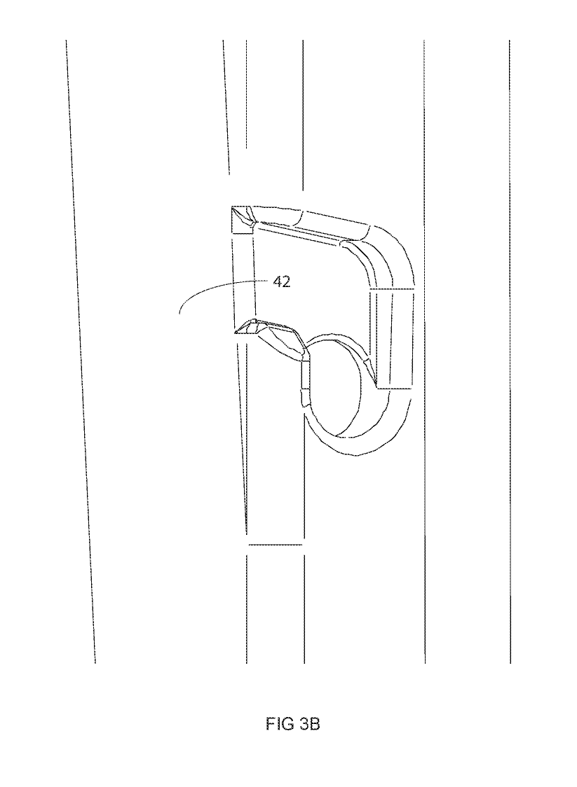

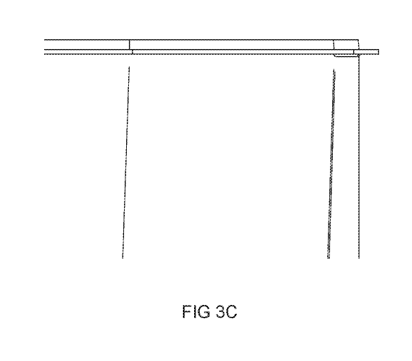

The blow-molded cart of the present invention, including a molded keyway for receiving a handle is shown in FIG. 1B. Cart 10 includes a hollow central body formed by front wall 14 (not shown) , rear wall 16, right wall 12, left wall 12′ with reinforcing flange 28 and floor 18 such that waste may be received within the hollow central body. Molded keyway section 32 for a handle is shown at the upper portion of rear wall 16. Cart body 10 includes cutouts 22, 22′ with fender sections 26, 26′ in sidewalls 12, 12′ for wheels (not shown) to be mounted on an axle retained by axle straps 24, 24′. Rear wall 16 includes longitudinal bearing surface 34 and at least two axle-retaining straps 24, 24′. The molded keyway section 32 is formed while waste cart body 10 is in the mold, by a slide that is extended during the blow molding process and is retracted prior to the unmolding of cart 10. The use of the slide allows for formation of the undercut portions of the keyway as explained further hereinbelow. Lower surface 36 is angled into the body of cart 10 with extending wall 38 extending downwardly to cart base 18. A kick surface 40 is formed in walls 36, 38 to assist a user in tipping the can back onto the wheels. Keyway section 32 includes a number trapezoidal keyways 50, 52, 54 that are spaced from one anotherto created spaced impressions 50′, 52′, 54′ that are mated to similarly sized keys on the handle assembly (shown in FIGS. 3A, 3B). The handle assembly is mated with the keyway assembly 32 while the polymer is warm and pliable after molding. Rear wall 16 includes detent features 56, 58, 60 that retain the handle assembly in keyways 50, 52, 54. As shown in FIG. 1B, the detent features 56, 58, 60 may be a number of recesses formed in rear wall 16 into which protrusions from the handle assembly are fitted.

The molded keyway is shown in perspective by FIG. 1C. The trapezoidal keyways 50, 52, 54 are formed on the rear wall 16 and spaced from one another to form impressions 50′, 52′, 54′ with detent features 56, 58, 60 in the keyways. The detent features 56, 58, 60 may be recesses or extensions formed in the rear wall. Keyways 50, 52, 54 include sidewalls 62, 64, 66 around the periphery thereof. Each keyway 50, 52, 54 is wider at impression 50′, 52′, 54′that at the top surface of the keyway section 32 such that sidewalls 62, 64, 66 form undercut sections. The undercuts sidewalls 62, 64, 66 in combination with detents 56, 58, 60 retain the handle in the keyway section 32 once the polymer of the cart has cooled. Side wall 12 and rim 28 are also shown.

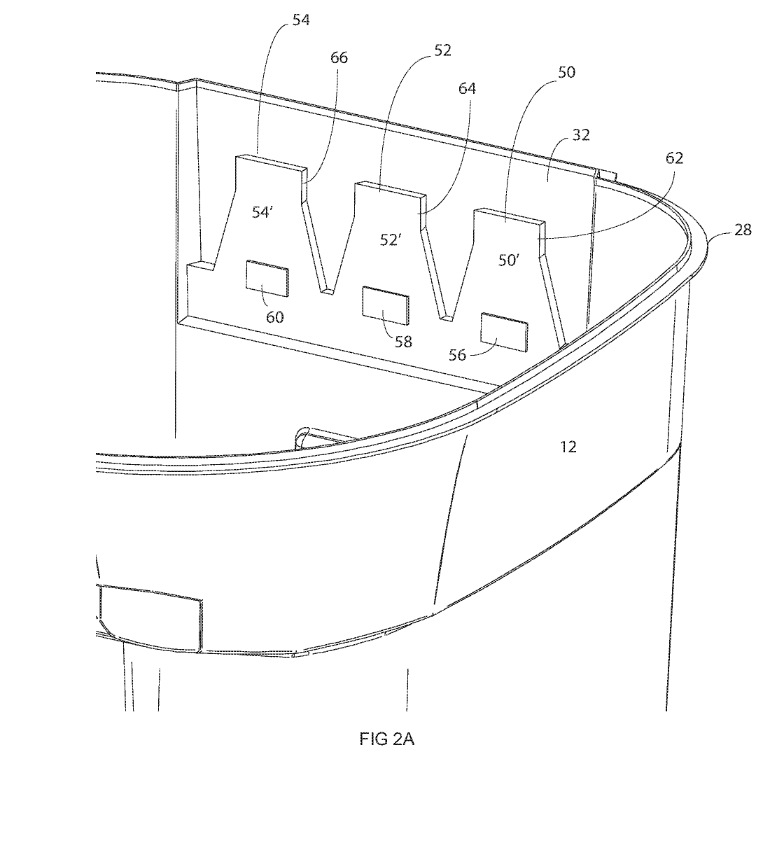

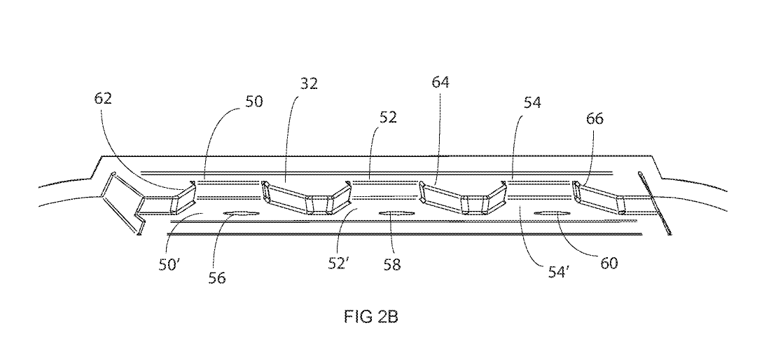

The interior of cart 12 and the molded keyway section 32 are shown in perspective by FIG. 2A. The trapezoidal keyways 50, 52, 54 are formed on the rear wall 16 and spaced from one another to form impressions 50′, 52′, 54′ with detent features 56, 58, 60 in the keyways. The detent features 56, 58, 60 may be recesses or extensions formed in the rear wall. Keyways 50, 52, 54 include sidewalls 62, 64, 66 around the periphery thereof. Each keyway 50, 52, 54 is wider at impression 50′, 52′, 54′that at the top surface of the keyway section 32 such that sidewalls 62, 64, 66 form undercut sections. The undercuts sidewalls 62, 64, 66 in combination with detents 56, 58, 60 retain the handle in the keyway section 32 once the polymer of the cart has cooled. Side wall 12 and rim 28 are also shown.

The molded keyway is shown in a lower perspective view by FIG. 2B. Keyways 50, 52, 54 include sidewalls 62, 64, 66 around the periphery thereof. Each keyway 50, 52, 54 is wider at impression 50′, 52′, 54′that at the top surface of the keyway section 32 such that sidewalls 62, 64, 66 form undercut sections. The undercuts sidewalls 62, 64, 66 in combination with detents 56, 58, 60 retain the handle in the keyway section 32 once the polymer of the cart has cooled.

The waste cart is formed in a blow molding manufacturing process. The blow molding process begins melting the polymer material and forming a forming it into a parison. The parison is a polymer sleeve that is clamped into a mold. The mold includes two halves, which are generally referred to as the pin half and the bushing half. The mold includes a slide in the mold for forming the undercut of the keyway. The slide is moved into position and the pin half and mold half are clamped around the parison. Air is then blown into the mold to force the parison against the mold and the slide to form the general shape of the can. Once the waste cart is formed and the plastic has cooled somewhat the slide is disengaged, the mold is opened and the waste cart is ejected.

The blow-molded cart of the present invention includes a molded handle assembly 80, as shown in FIG. 3A. The handle assembly 80 includes a base 81 having keys 82, 84, 86 to supports handle 80 when installed in keyways 50, 52, 54. Handle 94 is supported on base 81 by stanchions 96, 98, 100. Keys 82, 84, 86 have peripheral walls 110, 112, 114 that are canted inward such that the wall is wider at the base and will be firmly retained within the undercut sidewalls 62, 64, 66 of keyways 50, 52, 54. Handle 80 may include connection points 102, 104 for an optional lid. The keys 82, 84, 86 of the handle assembly 80 are forced into the keyways 50, 52, 54 of waste cart 10 after the blow-molding process, but while the polymer is warm and still relatively pliable. The handle assembly may be formed by blow-molding, injection molding or any other polymer molding process.

The underside of the molded handle assembly is shown in FIG. 3B. The handle assembly 80 includes a base 81 having keys 82, 84, 86 to supports handle 80 when installed in keyways 50, 52, 54. Handle 94 is supported on base 81 by stanchions 96, 98, 100. Keys 82, 84, 86 have peripheral walls 110, 112, 114 that are canted inward such that the wall is wider at the base and will be firmly retained within the undercut sidewalls 62, 64, 66 of keyways 50, 52, 54. Handle 80 may include connection points 102, 104 for an optional lid. The keys 82, 84, 86 of the handle assembly 80 are forced into the keyways 50, 52, 54 of waste cart 10 after the blow-molding process, but while the polymer is warm and still relatively pliable. Handle base 81 may include detents (or projections) 88, 90, 92 that are retained in the detents of projections 56, 58, 60 of the rear wall 16 of cart 10.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

We claim:

1. A blow-molded waste cart, comprising:
a blow-molded hollow body having a rear wall and a handle keyway assembly formed in the rear wall;
a floor, the body and floor form a waste receptacle; and
a handle installed in the keyway assembly.

2. The blow-molded waste cart of claim 1, further comprising:
at least one detent formed in the rear wall of the body.

3. The blow-molded waste cart of claim 2, further comprising:
a projection formed on the handle engaging the detent.

4. The blow-molded waste cart of claim 1, further comprising:
a plurality of spaced trapezoidal keyways forming the handle keyway.

5. The blow-molded waste cart of claim 5, further comprising:
undercut sections formed on the plurality of spaced trapezoidal keyways

6. The blow-molded waste cart of claim 1, further comprising:
a plurality of spaced trapezoidal keys on the handle.

7. The blow-molded waste cart of claim 6, further comprising:
undercut sections formed on the plurality of spaced trapezoidal keys.

8. A blow-molded body for a waste cart, comprising:
a blow-molded hollow body having a rear wall and a handle keyway formed in the rear wall;
a floor, the body and floor form a waste receptacle; and
a handle installed in the keyway.

9. The blow-molded body for a waste cart of claim 8, further comprising:
a detent formed in the rear wall of the body.

10. The blow-molded body for a waste cart of claim 9, further comprising:
a projection formed on the handle engaging the detent.

11. The blow-molded body for a waste cart of claim 8, further comprising:
a plurality of spaced trapezoidal keyways forming the handle keyway.

12. The blow-molded body for a waste cart of claim 11, further comprising:
undercut sections formed on the plurality of spaced trapezoidal keyways

13. The blow-molded body for a waste cart of claim 8, further comprising:
a plurality of spaced trapezoidal keys on the handle.

14. The blow-molded body for a waste cart of claim 13, further comprising:
undercut sections formed on the plurality of spaced trapezoidal keys.

15. A handle assembly for a blow-molded waste cart, comprising:
a mount section having a top surface and a lower surface;
a plurality of retention keys formed on the mounting surface; and
a handle projection from the top surface.

16. The handle assembly for a blow-molded waste cart of claim 15, wherein the retention keys are trapezoidal

17. The handle assembly for a blow-molded waste cart of claim 15, wherein the lower surface is generally planar

18. The handle assembly for a blow-molded waste cart of claim 15, wherein the retention keys are undercut.

19. The handle assembly for a blow-molded waste cart of claim 15, wherein the handle assembly is blow-molded.
